(19) United States
(12) Patent Application Publication
(10) Pub. No.: US 2024/0302840 A1
(43) Pub. Date: Sep. 12, 2024

(54) ELECTRONIC DEVICE AND METHOD OF CONTROLLING UNMANNED GROUND VEHICLE

(71) Applicant: ABB SCHWEIZ AG, Baden (CH)

(72) Inventors: Xuan Cao, Shanghai (CN); Yaodong Ni, Shanghai (CN); Dong Wu, Shanghai (CN)

(21) Appl. No.: 18/578,218

(22) PCT Filed: Sep. 16, 2021
(86) PCT No.: PCT/CN2021/118815

§ 371 Date: Jan. 10, 2024

(51) Int. Cl. G05D 1/223; G05D 1/224; G06F 3/02

(52) U.S. Cl. CPC G05D 1/223; G05D 1/224; G06F 3/0202

(57) ABSTRACT

An electronic device and a method for controlling an unmanned ground vehicle. The electronic device includes a portable body which has a housing and a cable extending outward from the housing, wherein the cable is adapted to electrically connect the electronic device to an unmanned ground vehicle. The electronic device includes an enabling assembly that has an enabling component at least partially arranged outside the housing, wherein the enabling assembly is adapted to provide an enabling signal to the unmanned ground vehicle via the cable in response to the enabling component being operated. The electronic device includes an operating assembly at least partially arranged outside the housing and adapted to, in response to reception of the enabling signal, provide an operation signal to the unmanned ground vehicle to control an operation of the unmanned ground vehicle.

### FIELD

Embodiments of the present disclosure generally relate to an unmanned ground vehicle, for example, automatic guided vehicle AGV or an autonomous mobile robot AMR, etc., and more specifically, to an electronic device and a method of controlling an unmanned ground vehicle.

### BACKGROUND

An unmanned ground vehicle (UGV) is a vehicle or a mobile robot that operates while in contact with the ground and without an onboard human presence. An automated guided vehicle or automatic guided vehicle (AGV) is a type of UGV that moves throughout a facility by following a set of predetermined paths. The AGV follows along markers or paths on the floor, or uses radio waves, vision cameras, magnets, or lasers for navigation or any other navigation system. An autonomous mobile robot (AMR) is a different class of UGV that has more capabilities than an AGV. AMRs are capable of free-movement and real-time path planning that enables them to collaborate in material handling tasks with humans. They are most often used in industrial applications to transport heavy materials around a large industrial building, such as a factory or warehouse.

UGVs can tow objects behind or on top of them in trailers to which they can autonomously attach. The trailers can be used to move raw materials or finished products. UGVs can also store objects on a bed. The objects can be placed on a set of motorized rollers (conveyor) and then be pushed off by reversing the rollers. UGVs are employed in a variety of industries including automotive, aerospace, pulp, paper, metals, newspaper, and general manufacturing. Transporting materials such as food, linen or medicine in hospitals is also performed by UGVs.

When UGVs are initially used or their operating environment changes, it is usually necessary to debug the UGVs to adapt the UGVs to the new environment. The debugging of the UGVs may comprise configuring parameters of the UGVs, manually jogging the UGVs, manually operating lifting pins, debugging PID (Proportion Integral Differential) control parameters, and displaying status and alarming information of the UGVs, etc.

### SUMMARY

Embodiments of the present disclosure provide an electronic device and a method for controlling an automatic guided vehicle.

In a first aspect, an electronic device is provided. The electronic device comprises a portable body comprising a housing and a cable extending outward from the housing, the cable adapted to electrically connect the electronic device to an unmanned ground vehicle: an enabling assembly comprising an enabling component at least partially arranged outside the housing, the enabling assembly adapted to provide an enabling signal to the unmanned ground vehicle via the cable in response to the enabling component being operated; and an operating assembly at least partially arranged outside the housing and adapted to, in response to reception of the enabling signal, provide an operation signal to the unmanned ground vehicle to control an operation of the unmanned ground vehicle.

By introducing the enabling assembly to provide the enabling signal, the UGV can be only operated with the electronic device by operating the operating assembly while pressing the enabling component. This ensures a double insurance to the operation of electronic device, which can effectively ensure personal safety and equipment safety. Furthermore, at least enabling signal provided by the enabling assembly is transmitted through the cable, rather than wirelessly, which can ensure that the enabling signal can be well received by the UGV without signal tampering or transmission errors, to thereby improve the reliability of the electronic device.

In some embodiments, the electronic device further comprises an emergency component at least partially arranged outside the housing and adapted to, in response to being pressed, provide an emergency signal to the unmanned ground vehicle to stop the operation of the unmanned ground vehicle. In this way, the UGV can be urgently stopped during the debugging of the UGV, thereby further improving personal safety and equipment safety:

In some embodiments, the electronic device further comprises a display arranged on the housing and adapted to at least present parameters and/or status of the unmanned ground vehicle. This allows users to have a more comprehensive understanding of the UGV's status, thereby improving the reliability of debugging the UGV.

In some embodiments, the enabling assembly is adapted to provide the enabling signal comprising a pair of check signals for dual-channel transmission. This can improve the reliability of the enabling signal and even the electronic device.

In some embodiments, the cable comprises an Ethernet cable to allow the operation signal to be transmitted. In this way, the operation signal can be transmitted in a reliable and low-cost manner.

In some embodiments, the operating assembly comprises a joystick adapted to generate the operation signal. In this way, the operation of the UGV can be controlled more intuitively and easily.

In some embodiments, the joystick and the display are arranged on a first side of the housing, and the enabling component is arranged on a second side of the housing opposite to the first side. This makes the arrangement of the electronic device more reasonable.

In some embodiments, the housing comprises a handheld part arranged on the second side to facilitate holding of the electronic device, and wherein the enabling component is arranged adjacent to the handheld part to allow the user to press the enabling component while holding the electronic device with one hand. This arrangement makes the electronic device more ergonomic.

In some embodiments, the electronic device further comprises auxiliary components at least partially arranged outside the housing and adapted to generate an adjustment signal to adjust the parameters of the unmanned ground vehicle and/or to adjust a presentation present on the display: The auxiliary components make the debugging of the UGV more easily.

In some embodiments, the electronic device is a standardized teach pendant. In this way, for factories or companies equipped with various kinds of UGVs, robots or the like, one or more standardized teach pendants with the same specification can be used, which can significantly reduce costs for the pendant devices. Furthermore, the user merely needs to operate the electronic devices with the same specification to debug different devices, e.g., UGVs or robots without switching between different teach pendants, thereby reducing difficulty for the personal to debug the different devices.

In a second aspect, a method of controlling an unmanned ground vehicle is provided. The method comprises obtaining an enabling signal from an enabling assembly of an electronic device: obtaining an operation signal from an operating assembly of the electronic device; and controlling an operation of the unmanned ground vehicle according to the operation signal in response to reception of the enabling signal. In this way, the debugging of the UGV can be more reliable and easy.

In some embodiments, the method further comprises obtaining an emergency signal from the emergency component of the electronic device; and stopping the operation of the unmanned ground vehicle in response to reception of the emergency signal. In this way, the UGV can be urgently stopped during the debugging of the UGV, thereby further improving personal safety and equipment safety.

In some embodiments, the method further comprises obtaining an adjustment signal; and adjusting corresponding one or more of parameters according to the adjustment signal.

In some embodiments, the method further comprises obtaining a pair of check signals of the enabling signal from the enabling assembly of the electronic device; and comparing the pair of the check signals to verify a validity of the enabling signal.

In some embodiments, the method further comprises transmitting information involving parameters and/or status of the unmanned ground vehicle to the electronic device.

In a third aspect, a computer readable storage medium is provided. The computer readable storage medium has computer readable program instructions stored thereon which, when executed by a control module, cause the control module to perform the method as mentioned in the above second aspect.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent the same components.

FIG. 1 shows a perspective view of an automatic guided vehicle according to embodiments of the present disclosure;

FIG. 2 shows a perspective view of an electronic device coupled to an automatic guided vehicle according to embodiments of the present disclosure:

FIG. 3 shows a perspective view of an electronic device viewed from a rear of the electronic device according to embodiments of the present disclosure:

FIG. 4 shows a bottom view of an electronic device held by one hand according to embodiments of the present disclosure; and

FIG. 5 shows a flowchart illustrating a method of controlling an automatic guided vehicle with an electronic device according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

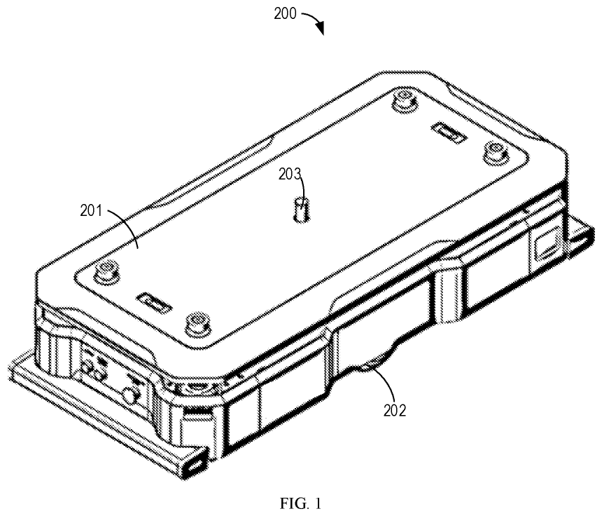

There are currently various kinds of unmanned ground vehicles (UGVs), for example, automated guided vehicles or automatic guided vehicles (AGVs 200) or autonomous mobile robots (AMRs), or the like, used in industrial applications to transport heavy materials around a large industrial building, such as a factory or warehouse. FIG. 1 shows a perspective view of a common UGV 200, which typically comprises at least one motor, wheels 202 driven by the motor, a loading platform 201, sensors and a control module, etc. The control module can control the motor to drive the wheels 202 to move along predetermined path or according to input instructions and/or information obtained by the sensors. The UGV 200 may further comprise a tray arranged on top of the loading platform. The tray may comprise a hole or a recess coupled with a lifting pin 203 which can protrude from the loading platform 201. The lifting pin 203 may be retracted to allow the tray to be removed or moved away from the loading platform 201.

As mentioned above, when UGVs 200 are initially used or their operating environment changes, it is usually necessary to debug the UGVs 200 to adapt the UGVs 200 to the new environment. The debugging of the UGVs 200 may comprise configuring parameters of the UGVs 200, manually jogging the UGVs 200, manually operating lifting pins, debugging PID control parameters, and display 105ing status and alarming information of the UGVs 200, etc.

To facilitate the debugging of UGVs 200, one approach of conventional solutions uses a human-machine interface vertically arranged on the loading platform. The human-machine interface may comprise a display 105 to facilitate presentation and/or configuration of parameters of the UGV 200 and several buttons with which the UGV 200 may be moved or the lifting pin 203 may be lifted, etc.

However, due to the fixed position relative to the UGV 200, the human-machine interface is not convenient to operate, especially when the UGV 200 needs to be moved. Another approach in the conventional solutions involves using a remote control device such as a handle, a phone or a pad to manually control or debug an UGV 200. The remote control device is typically coupled to the UGV 200 wirelessly and comprises several buttons or interfaces with which the UGV 200 may be maintained or debugged.

A problem resulting from this approach is that the remote control device cannot obtain and present status and alarming information from the UGV 200, causing the inconvenience of control and the risk of damage to the UGV 200. Furthermore, the above two mentioned approaches both encounter a problem of failing to eliminate the risk of misoperation which may cause personal injury or equipment damage during the debugging of the UGV 200 using the human-machine interface or the remote control device.

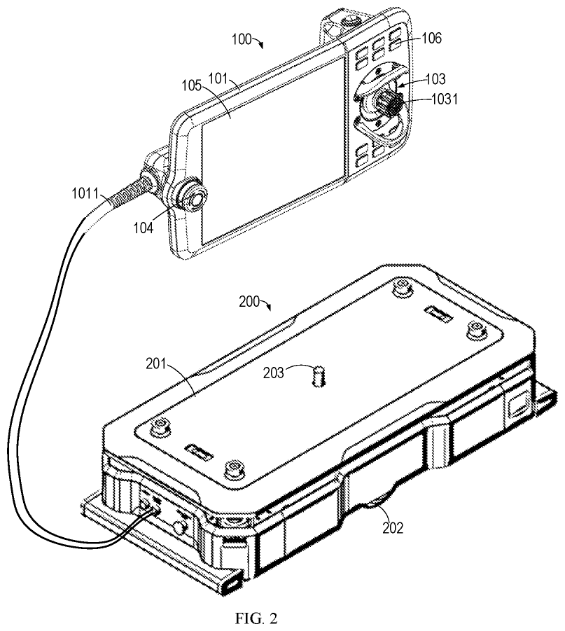

In order to at least partially address the above and other potential problems, embodiments of the present disclosure provide an electronic device 100 for manually controlling or debugging an UGV 200. Now some example embodiments will be described with reference to FIGS. 2-4.

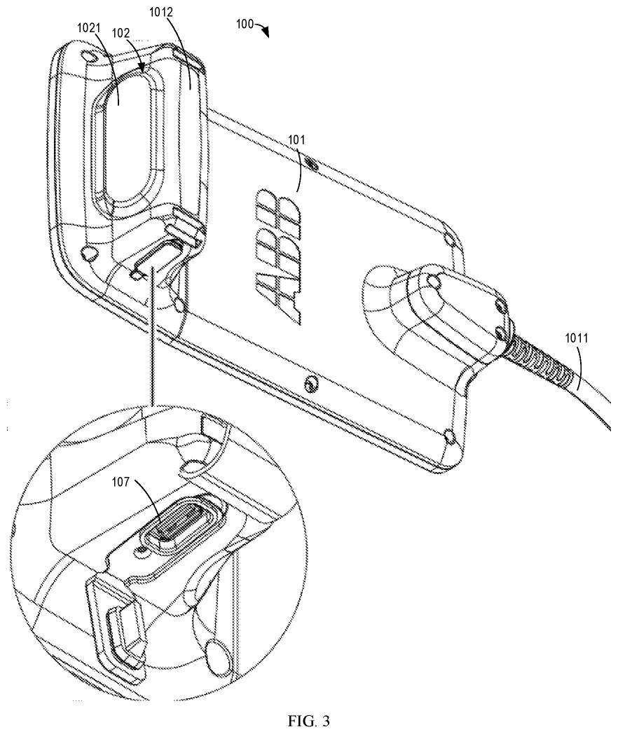

FIG. 2 shows a perspective view of the electronic device 100 coupled to an UGV 200 and FIG. 3 shows a perspective view of the electronic device 100 viewed from the rear of the electronic device 100. As shown in FIGS. 2 and 3, generally, the electronic device 100 according embodiments of the present disclosure comprises a portable body, an enabling assembly 102 and an operating assembly 103.

The portable body, as the name implies, is portable to facilitate the operation of the electronic device 100. The portable body comprises a housing 101 for receiving a printed circuit board (PCB) where portions, e.g., circuits of the enabling assembly 102 and operating assembly 103 are arranged with other necessary circuits or modules. The portable body may further comprise a cable 1011 extending outward from the housing 101. The cable 1011 may be fixedly coupled to an interface of the printed circuit board to thereby provide electrical connection between the electronic device 100, such as the enabling assembly 102 and the operating assembly 103 thereof, and the UGV 200. In some alternative embodiments, the cable 1011 may also be pluggably coupled to the corresponding interface of the electronic device 100.

At another end of the cable 1011, a plug (not shown) may be provided. The plug may be plugged into a corresponding socket of the UGV 200 to establish the electrical connection between the UGV 200 and the electronic device 100 during the debugging of the UGV 200. In this way, an operator can debug the UGV 200 at a position far away from the UGV 200, thereby improving the safety and convenience of debugging and operation. After the UGV 200 has been well debugged, the plug may be pulled out of the socket of the UGV 200 to allow the UGV 200 to be operated automatically. The cable 1011 may have a suitable length allowing the electronic device 100 to control the movement of the UGV 200 in a predetermined range without restriction.

As shown in FIG. 2, the operating assembly 103 at least partially arranged outside the housing 101. For example, in some embodiments, the operating assembly 103 may comprise a joystick 1031 arranged outside the housing 101 to be operated by an operator. Besides the joystick 1031, the operating assembly 103 may further comprise the necessary circuits for example arranged on the printed circuit board adapted to generate the operation signals according to the operation of the joystick 1031 and provide the generated operation signals to the UGV 200.

In this way, operation signals to control the UGV 200 can be generated by means of the relating circuits of the operating assembly 103 in response to the operation of the operation of the joystick 1031. The joystick 1031 may be operated, for example swung in all direction or rotated around its own axis, to generate the corresponding operation signal.

For example, in some embodiments, when the joystick 1031 is swung to the left, the operation signal to control the UGV 200 to turn left may be generated by the relating circuits of the operating assembly 103. Similarly, when the joystick 1031 is swung forward, i.e., away from the operator, the operation signal to control the UGV 200 to move forward may be generated. Furthermore, when the joystick 1031 is rotated about its own axis, the operation signal to control the UGV 200 to rotate may be generated. In some embodiments, the running speed and the angle of turning of the UGV can be determined according to the strength and amplitude of the joystick being swung.

It is to be understood that the above embodiments illustrating the relationship between the operation of the joystick 1031 and the generated operation signal are merely illustrative, without suggesting any limitation as to the scope of the present disclosure. Any suitable correspondence between the operation of the joystick 1031 and the generated operation signal is also possible. For example, in some alternative embodiments, when the joystick 1031 is rotated about its own axis, the operation signal to control the lifting pin 203 to be lifted may be generated.

It is further to be understood that the above embodiments where the operating assembly 103 comprises the joystick 1031 are merely illustrative, without suggesting any limitation as to the scope of the present disclosure. Any other suitable arrangements or structures that can be used to generate the operation signals are also possible. For example, in some alternative embodiments, the operating assembly 103 may further comprise direction buttons or the like to generate the operation signals to control the movement of the UGV 200.

In some embodiments, the operation signal may be provided to the UGV 200 via Ethernet. Ethernet is a family of wired networking technologies commonly used in local area networks (LAN), metropolitan area networks (MAN) and wide area networks (WAN). What Ethernet is not, though, is wireless. Compared to wireless LAN (WLAN) technology, Ethernet is typically less vulnerable to disruptions. It can also offer a greater degree of network security and control than wireless technology since devices must connect using physical cabling. This makes it difficult for outsiders to access network data or hijack bandwidth for unsanctioned devices. With the operation signal transmitted via Ethernet, the reliability and security of the electronic device 100 can be significantly improved. In some embodiments, the cable 1011 may further comprise an Ethernet cable to allow the operation signal to be transmitted to the UGV 200.

In comparison to the convention solutions, the UGV 200 cannot be moved only relying on the operation signals. The UGV 200 can only be moved in response to reception of an enabling signal and according to the operation signals, which can improve safety of the electronic device 100 during the debugging of the UGV 200 using the electronic device 100. That is, to control the operation of the UGV 200 with the operation signals, the enabling signal provided by the enabling assembly 102 is necessary according to embodiments of the present disclosure.

The enabling assembly 102 comprises an enabling component 1021, e.g., an enabling button, at least partially arranged outside the housing 101. The enabling component 1021 may be operated, e.g., pressed to generate the enabling signal. Furthermore, similar to the operating assembly 103, besides the enabling component 1021, the enabling assembly 102 may further comprise necessary circuits for example arranged on the printed circuit board adapted to generate the enabling signals in response to the operation of the enabling component 1021. The circuits of the enabling assembly 102 may also provide the generated enabling signals to the UGV 200 through the cable 1011.

With both of the enabling signal and the operation signal, the UGV 200 can be operated with the electronic device 100. Once the enabling component 1021 is released, the enabling signal will be eliminated. As a result, the UGV 200 cannot be moved even a user operates the joystick 1031. That is, the UGV 200 can be only operated with the electronic device 100 by operating the operating assembly 103 while pressing the enabling component 1021. This ensures a double insurance to the operation of electronic device 100, which can effectively ensure personal safety and equipment safety.

Furthermore, it is to be noted that at least enabling signal provided by the enabling assembly 102 is transmitted through the cable 1011, rather than wirelessly. This arrangement can ensure that the enabling assembly 102 can be well received by the UGV 200 without signal tampering or transmission errors, to thereby improve the reliability of the electronic device 100.

In some embodiments, to further improve the reliability of the electronic device 100, the enabling signal may further comprise a pair of check signals adapted for dual-channel transmission. The pair of check signals can be verified each other for example by the control module of the UGV 200. In this way, the enabling signal can be mutually checked to ensure the reliability of the enabling signal and the electronic device 100.

In some embodiments, the electronic device 100 may be a standardized teach pendant. A teach pendant, also called a “teach box,” means a control box for programming the motions of an UGV, a robot or the like. The standardized teach pendant means that the teach pendant is standardized and can be used in various kinds of UGVs 200, robots or the like. In this way, for factories or companies equipped with various kinds of UGVs 200, robots or the like, one or more standardized teach pendants with the same specification can be employed, which can significantly reduce costs for the pendant devices. Furthermore, the user merely needs to operate the electronic devices 100 with the same specification to debug different devices, e.g., UGVs 200 or robots without switching between different teach pendants, thereby reducing difficulty for the personal to debug the different devices.

To further improve the safety of the electronic device 100 during the debugging of the UGV 200, in some embodiments, the electronic device 100 may further comprise an emergency component 104 at least partially arranged outside the housing 101. The emergency may be an emergency button that can be pressed to provide an emergency signal to the UGV 200 to thereby stop the operation of the UGV 200. For example, in some embodiments, when an operator discovers that the UGV 200 may collide with an obstacle during the debugging of the UGV 200 with the electronic device 100, the UGV 200 can be stopped urgently by pressing the emergency component 104 to improve safety of the electronic device 100. Similar to the enabling signal, the emergency signal may also be transmitted to the UGV 200 through the cable 1011, to thereby improve the reliability of the electronic device 100.

In some embodiments, the electronic device 100 may further comprise a display 105 arranged on the housing 101. The display 105 can be used to at least present parameters and/or status of the UGV 200. For example, in some embodiments, the control module of the UGV 200 can provide the parameters and/or status of the UGV 200 to the electronic device 100 to allow the parameters and/or status to be present on the display 105. In this way, the operator can keep abreast of the parameters and/or status of the UGV 200 in time.

The display 105 may be touch-sensitive in some embodiments, which allow the parameters present on the display 105 to be adjusted by touching the display 105. In this way, convenience of operation of the electronic device 100 can be effectively improved. In some alternative embodiments, the display 105 may also be an ordinary display 105 without touch-sensitive functions, which can further reduce costs of the electronic device 100.

In some embodiments, alternatively or additionally, the electronic device 100 may further comprise several auxiliary components 106, e.g., auxiliary buttons, at least partially arranged outside the housing 101. The auxiliary components 106 may be physical buttons or touch-sensitive panels that can be operated, e.g., pressed or touched, to generate an adjustment signal to adjust the parameters of the UGV 200. Alternatively or additionally, in some embodiments, the auxiliary components 106 may be operated to adjust a presentation present on the display 105.

For example, the auxiliary components 106 may at least comprise a switching button, a selection button, a confirmation button and a modification button. The switching button may be used to switch the presentation present on the display 105 for example between the status and the parameters of the UGV 200. The selection button may be used to adjust the selected parameter by moving the cursor in the display 105. The modification button may be used to modify the selected parameter and the confirmation button may be used to confirm the parameter to be modified. In this way, the parameters of the UGV 200 can be adjusted easily.

It is to be understood that the above embodiments where the auxiliary components comprise the above mentioned buttons are merely illustrative, without suggesting any limitation as to the scope of the present disclosure. Any suitable buttons are also possible. For example, in some embodiments, alternatively or additionally, the auxiliary components 106 may further comprise motion mode button allowing the operator to toggle the motion mode for example between reorient and linear.

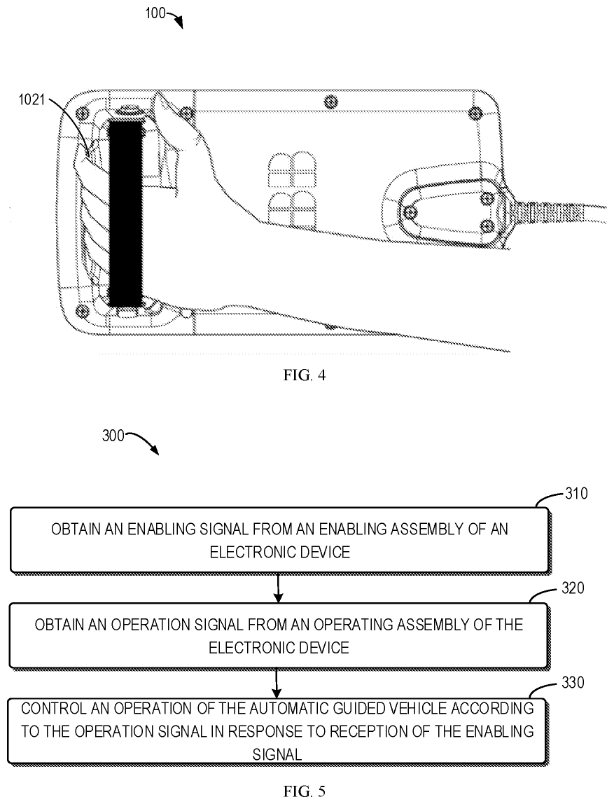

As shown in FIGS. 2 and 3, in some embodiments, the display 105 and the joystick 1031 may be arranged on a first side of the housing 101, and the enabling component 1021 may be arranged on a second side of the housing 101 opposite to the first side. Furthermore, in some embodiments, the electronic device 100 may further comprise a handheld part 1012 arranged on the second side of the housing 101 to facilitate holding of the electronic device 100, as shown in FIG. 4.

The handheld part 1012 may comprise a band, which can be used to restrict the hand between the band and the housing 101. The band may have a certain elasticity to facilitate clamping of the user's hand. In addition, the enabling component 1021 may be arranged adjacent to the handheld part 1012. In this way, an operator can keep pressing the enabling component 1021 while holding the electronic device 100 via the handheld part 1012 with one hand. In this way, the operator's another hand can operate the joystick 1031 to thereby control the operation of the UGV 200.

Referring back to FIG. 3, in some embodiments, the electronic device 100 may further comprise an Universal Serial Bus (USB) interface 107. The USB interface 107 may be used for external devices to be connected to thereby establish data and/or power connections between the external device and the electronic device 100. In this way, the electronic device 100 can exchange data with the external device more conveniently, thereby improving the ease of use of the electronic device 100.

In some embodiments, to prevent dirt or water from entering the USB interface 107, a cap to cover the USB interface 107 when the USB interface 107 is not used may be provided. The cap may be made of elastic material such as rubber or silicone rubber to prevent possible damage to the USB interface when covering it. Furthermore, a portion of the cap may be fixed arranged on the housing 101 to prevent the cap from being lost.

It is to be understood that the above embodiments where the electronic device 100 comprises an USB interface as shown in FIG. 3 are merely illustrative, without suggesting any limitation as to the scope of the present disclosure. Any suitable interface is also possible. For example, in some embodiments, alternatively or additionally, the electronic device 100 may further comprise any appropriate wired or wireless interface, such as infrared interface, Bluetooth interface, Wi-Fi interface, serial port, COM port, TTL, RS232 or RS484 interface.

According to other aspects of the present disclosure, a method of controlling an UGV 200 is provided. FIG. 5 shows a flowchart of the method. The method may be performed by the above mentioned control module of the UGV 200 to allow the UGV 200 to be debugged or operated. To achieve this end, a computer readable storage medium is provided. The computer readable storage medium has computer readable program instructions stored thereon which, when executed by a control module, cause the control module to perform the method as mentioned. In some alternative embodiments, the method may also be performed by a dedicated control unit of the UGV 200. In the following, the concept of the present disclosure will be described by using an example of the method being by the control module. It should be understood that the method may also be performed by other control unit or processing unit, and will not be described separately in the following.

As shown in FIG. 5, in block 310, the control module obtains an enabling signal from the enabling assembly 102 of the electronic device 100. In some embodiments, the control module may verify the validity of the enabling signal by comparing check signals of the enabling signal provided via dual-channel transmission. In the meantime or after the enabling signal is obtained, in block 320, the control module obtains the operation signal from the operating assembly 103 of the electronic device 100.

In block 330, the operation of the UGV 200 can be controlled according the operation signal in response to reception of the enabling signal. In this way, a double insurance to the operation of electronic device 100 can be obtained, which can effectively ensure personal safety and equipment safety.

In some embodiments, the control module may further obtain the emergency signal from the emergency component 104. In response to the reception of the emergency signal, the operation of the UGV 200 may be urgently stopped. In this way, the safety for debugging the UGV 200 with the electronic device 100 can be significantly improved.

In some embodiments, the control module may further obtain the adjustment signal from the auxiliary components 106. Upon reception of the adjustment signal, the control module can then adjust corresponding one or more of the parameters of the UGV 200. In some embodiments, the control module can transmit information involving parameters and/or status of the UGV 200 to the electronic device 100. In this way, the parameters comprising the initial parameters and/or adjusted parameters and/or status of the UGV 200 can be present in the display 105 in time.

It should be appreciated that the above detailed embodiments of the present disclosure are only for exemplifying or explaining principles of the present disclosure and do not limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An electronic device comprising:
a portable body comprising a housing and a cable extending outward from the housing, the cable adapted to electrically connect the electronic device to an unmanned ground vehicle;
an enabling assembly comprising an enabling component at least partially arranged outside the housing, the enabling assembly adapted to provide an enabling signal to the unmanned ground vehicle via the cable in response to the enabling component being operated; and
an operating assembly at least partially arranged outside the housing and adapted to, in response to reception of the enabling signal, provide an operation signal to the unmanned ground vehicle to control an operation of the unmanned ground vehicle.

2. The electronic device of claim 1, further comprising:
an emergency component at least partially arranged outside the housing and adapted to, in response to being pressed, provide an emergency signal to the unmanned ground vehicle to stop the operation of the unmanned ground vehicle.

3. The electronic device of claim 1, further comprising:
a display arranged on the housing and adapted to at least present parameters and/or status of the unmanned ground vehicle.

4. The electronic device of claim 1, wherein the enabling assembly is adapted to provide the enabling signal comprising a pair of check signals for dual-channel transmission.

5. The electronic device of claim 1, wherein the cable comprises:
an Ethernet cable to allow the operation signal to be transmitted.

6. The electronic device of claim 3, wherein the operating assembly comprises:
a joystick adapted to generate the operation signal.

7. The electronic device of claim 6, wherein the joystick and the display are arranged on a first side of the housing, and the enabling component is arranged on a second side of the housing opposite to the first side.

8. The electronic device of claim 7, wherein the housing comprises:
a handheld part arranged on the second side to facilitate holding of the electronic device, and
wherein the enabling component is arranged adjacent to the handheld part to allow the user to press the enabling component while holding the electronic device with one hand.

9. The electronic device of claim 3, further comprising:
auxiliary components at least partially arranged outside the housing and adapted to generate an adjustment signal to adjust the parameters of the unmanned ground vehicle and/or to adjust a presentation present on the display.

10. The electronic device of claim 1, wherein the electronic device is a standardized teach pendant.

11. A method of controlling an unmanned ground vehicle, comprising:
obtaining an enabling signal from an enabling assembly of an electronic device;
obtaining an operation signal from an operating assembly of the electronic device; and
controlling an operation of the unmanned ground vehicle according to the operation signal in response to reception of the enabling signal.

12. The method of claim 11, further comprising:
obtaining an emergency signal from the emergency component of the electronic device; and
stopping the operation of the unmanned ground vehicle in response to reception of the emergency signal.

13. The method of claim 11, further comprising:
obtaining an adjustment signal; and
adjusting corresponding one or more of parameters according to the adjustment signal.

14. The method of claim 11, further comprising:
obtaining a pair of check signals of the enabling signal from the enabling assembly of the electronic device; and
comparing the pair of the check signals to verify a validity of the enabling signal.

15. The method of claim 11, further comprising:
transmitting information involving parameters and/or status of the unmanned ground vehicle to the electronic device.

16. A computer readable storage medium having computer readable program instructions stored thereon which, when executed by a control module, cause the control module to perform the method of claim 11.

17. The computer readable storage medium of claim 16, wherein the method further comprises:
obtaining an emergency signal from the emergency component of the electronic device; and
stopping the operation of the unmanned ground vehicle in response to reception of the emergency signal.

18. The computer readable storage medium of claim 16, wherein the method further comprises:
obtaining an adjustment signal; and
adjusting corresponding one or more of parameters according to the adjustment signal.

19. The computer readable storage medium of claim 16, wherein the method further comprises:
obtaining a pair of check signals of the enabling signal from the enabling assembly of the electronic device; and
comparing the pair of the check signals to verify a validity of the enabling signal.

20. The computer readable storage medium of claim 16, wherein the method further comprises:
transmitting information involving parameters and/or status of the unmanned ground vehicle to the electronic device.
